(19) United States
(12) Patent Application Publication
(10) Pub. No.: US 2006/0114095 A1
(43) Pub. Date: Jun. 1, 2006

(54) Electric component and its manufacturing material

(75) Inventor: Mu-Tu Lee, Taipei County (TW)

Correspondence Address: BIRCH STEWART KOLASCH & BIRCH, PO BOX 747, FALLS CHURCH, VA, 22040-0747, US

(73) Assignee: JUNG FONG ELECTRONICS CO., LTD.

(21) Appl. No.: 11/267,271

(22) Filed: Nov. 7, 2005

(30) Foreign Application Priority Data
Nov. 26, 2004 (TW) 093136398

(51) Int. Cl. H01F 27/28

(52) U.S. Cl. 336/182; 335/281

(57) ABSTRACT

The present invention discloses an electric component and its manufacturing material, of which a plurality of electric component groups is produced on a carrier tape and each electric component group is made of a first and a second symmetric silicon plates, and the first and second silicon steel plates individually have a long end section, a short end section and a connecting section for connecting the long and short sections, and the first and second silicon steel plates are interested on the carrier tape to define a structure arranged in the order of the long end section, the short end section, the short end section and the long end section as to reduce the waste of material on the carrier tape and save unnecessary material costs.

### FIELD OF THE INVENTION

The present invention relates to an electric component and its manufacturing material, more particularly to an electric component to be applied to a U-shape silicon steel plate, such that a U-shape silicon plate group is produced on a carrier tape to reduce a waste of materials and lower unnecessary material costs effectively.

### BACKGROUND OF THE INVENTION

In general, an electric component such as an inductor, a transformer, or a choke coil usually adopts a connecting type silicon steel plate wrapped by a coil for its electric connection to produce an electromagnetic field. Various different combinations of iron cores are designed according to the inductance and the overall volume of the structure and four common ones include the EE-shape, EI-shape, UU-shape and UI-shape. For manufacturing, the I-shape silicon steel plate is the simplest one, and the E-shape and U-shape silicon steel plates generally cause problems to the production due to their special shapes. FIG. 1 shows a schematic view of the current existing carrier tape 10 with a U-shape silicon steel plate 1a, 1b. In the figure, the carrier tape 10 contains a plurality of electric components thereon, but each electric component block for the production is restricted by the special shape of the U-shape silicon steel plate 1a, 1b. Since the U-shape silicon steel plate 1a, 1b produces a magnetic force by the design of equal length of two end sections 21, 23, 24, 26, therefore the two end sections 21, 23, 24, 26 of two symmetric U-shape silicon steel plates 1a and 1b can be aligned correspondingly with each other. In such production process, two U-shape silicon steel plates 1a and 1b and one I-shape silicon steel plate 1c are produced at the same time. As to the manufacture, if the UU-shape silicon plate is used to produce electric components, then manufacturers have to make other arrangements for the material planning of the I-shape silicon steel plate 1c; if the UI-shape silicon plate is used to produce electric components, then manufacturers have to handle the problem of preparing additional quantity of material to cover a great deal of the remained U-shape silicon steel plate 1a, 1b. Manufacturers cannot afford such unnecessary waste of materials, since scraping the remained material causes an unnecessary increase of the manufacturing cost.

### SUMMARY OF THE INVENTION

Therefore, it is a primary objective of the present invention to solve the foregoing problems and avoid the existing deficiencies by providing a novel method for producing a U-shape silicon steel plate, and each electric component group comprises a first and a second symmetric silicon steel plates, and the first and second silicon steel plates individually have a long end section, a short end section, and a connecting section for connecting the long and short end sections, and the first and second silicon steel plates are intersected on a carrier tape to define a structure arranged in the order of the long end section, the short end section, the long end section and the short end section as to reduce the material waste of the carrier tape and save unnecessary material costs.

### BRIEF DESCRIPTION OF THE DRAWINGS

FIG. 1 is a schematic view of a carrier tape containing electric components according to a prior art.

FIG. 2A is a schematic view of a carrier tape containing electric components according to the present invention.

FIGS. 2B to 2D are schematic views of forming the electric component assembly according to the present invention.

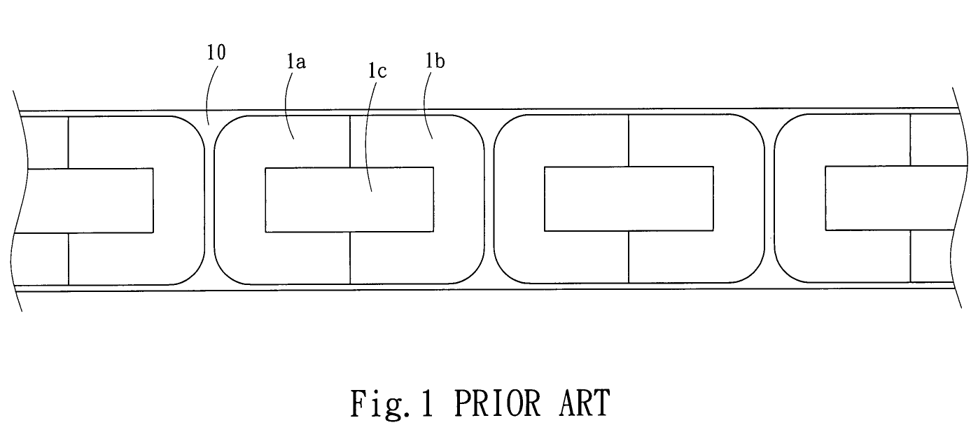

### DETAILED DESCRIPTION OF THE PREFERRED EMBODIMENTS

The above and other objects, features and advantages of the present invention will become apparent from the following detailed description taken with the accompanying drawing.

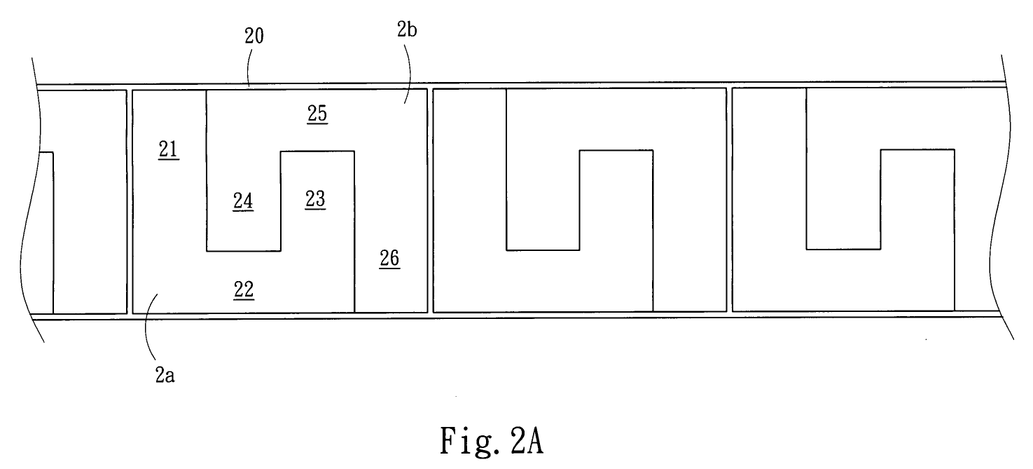

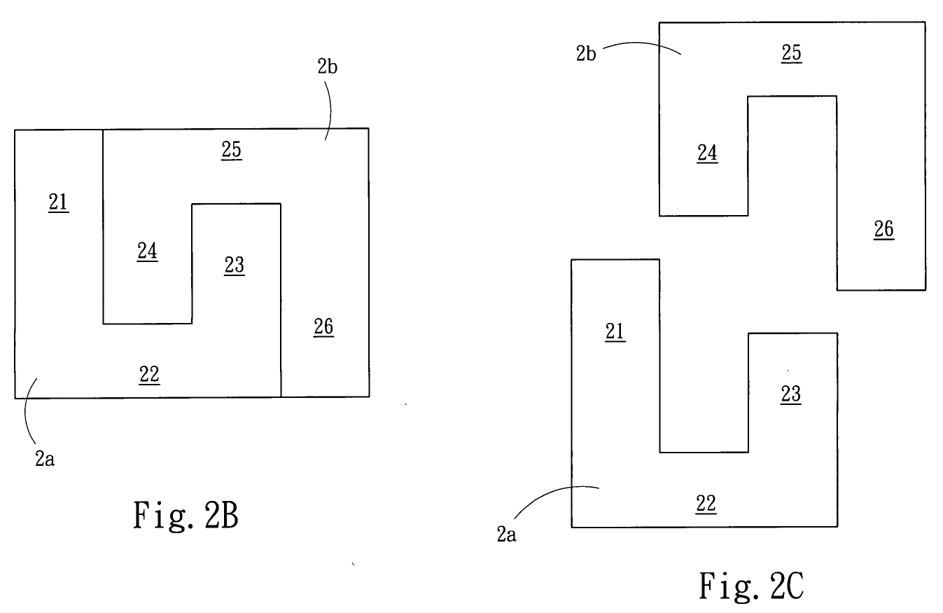

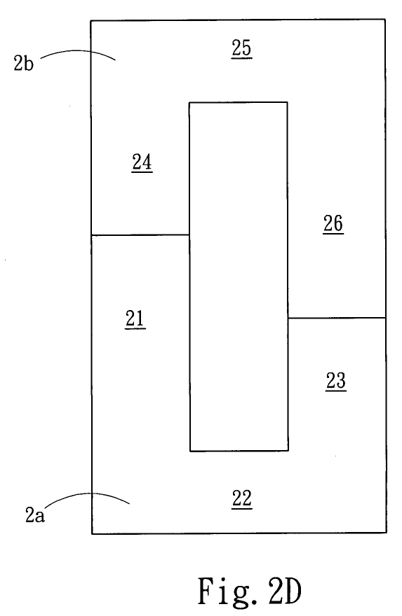

Please refer to FIG. 2A for the schematic view of a carrier tape containing electric components according to the present invention. In the figure, the electric component and its manufacturing material in accordance with the present invention produce a plurality of electric component groups on a carrier tape 20, wherein each electric component group is made of a first and a second symmetric silicon plates 2a and 2b, and the first and second silicon steel plates 2a and 2b individually have a long end section 21, 26, a short end section 23, 24 and a connecting section 22, 25 for connecting the long and short sections 21, 23, 24, 26 and the length of the long end section 21, 26 is equal to the sum of the length of the short end section 23, 24 and the length of the connecting end 22, 25 (such that the vertical height of the first and second silicon steel plates 2a and 2b is equal to their transversal width). In the manufacture, the first and second silicon steel plates 2a and 2b are interested on the carrier tape 20 to define a structure arranged in the order of the long end section 21, the short end section 24, the short end section 23 and the long end section 26 as to form a square block on the carrier tape 20 by the first and second silicon steel plates 2a and 2b. Obviously, the two U-shape silicon steel plates are formed simply on the carrier tape 20, and thus there will be no extra material remained as the prior art does. Since the square block for production is adopted, therefore the invention can greatly reduce the waste of material on the carrier tape 20.

In FIG. 2B, the first silicon steel plate 2a and the second silicon steel plate 2b are removed after the production is completed, and then the first silicon steel plate 2a is separated from the second silicon steel plate 2b as shown in FIG. 2C. In the assembling process, the first silicon steel plate 2a is separated from the second silicon steel plate 2b first, and then the long end section 21 of the first silicon steel plate 2a is connected to the short end section 24 of the second silicon steel plate 2b, and the short end section 23 of the first silicon steel plate 2a is connected to the long end section 26 of the second silicon steel plate 2b as shown in FIG. 2D as to provide an equivalent structure of the existing UU-shape electric component.

While the invention has been described by means of specific embodiments, numerous modifications, and variations could be made thereto by those skilled in the art without departing from the scope and spirit of the invention set forth in the claims.

What is claimed is:

1. An electric component and its manufacturing material, having a plurality of groups of electric components produced on a carrier tape, characterized in that:
each group of electric components, comprising a first silicon steel plate and a second silicon steel plate, both being symmetrical to each other and each having a long end section, a short end section, and a connecting section for coupling said long and short end sections, and said first silicon steel plate and said second silicon steel plate being intersected to define a structure arranged in the order of said long end section, said short end section, said short end section and said long end section.

2. The electric component and its manufacturing material of claim 1, wherein said long end section has a length equal to the sum of the length of said short end section and the length of said connecting section.

3. The electric component and its manufacturing material of claim 1, wherein said first silicon steel plate and said second silicon steel plate have a vertical height equal to their transversal width.

4. The electric component and its manufacturing material of claim 1, wherein said first silicon steel plate and said second silicon steel plate form a square block on said carrier tape.

5. An electric component, comprising two end sections and a connecting section for coupling said two end sections, and said two end sections have asymmetrical and unequal lengths.

6. The electric component of claim 5, wherein said long end section has a length equal to the sum of the length of said short end section and the length of said connecting section.

7. The electric component of claim 5 having a vertical height equal to its transversal width.
